(19) United States
(12) Patent Application Publication
(10) Pub. No.: US 2014/0358793 A1
(43) Pub. Date: Dec. 4, 2014

(54) Unforgeable Noise-Tolerant Quantum Tokens

(71) Applicants: Fernando Pastawski, Garching (DE); J. Ignacio Cirac, Garching (DE); Liang Jiang, Pasadena, CA (US); Norman Yao, Cambridge, MA (US); Mikhail Lukin, Cambridge, MA (US)

(72) Inventors: Fernando Pastawski, Garching (DE); J. Ignacio Cirac, Garching (DE); Liang Jiang, Pasadena, CA (US); Norman Yao, Cambridge, MA (US); Mikhail Lukin, Cambridge, MA (US)

(73) Assignee: PRESIDENT AND FELLOWS OF HARVARD COLLEGE, Cambridge, MA (US)

(21) Appl. No.: 14/366,341

(22) PCT Filed: Dec. 23, 2012
(86) PCT No.: PCT/US2012/701564

§ 371 Date: Jun. 18, 2014

Related U.S. Application Data
(60) Provisional application No. 61/579,805, filed on Dec. 23, 2011.

(51) Int. Cl. G06Q 20/38; H04L 9/08; H04L 9/32; G06Q 20/04

(52) U.S. Cl. CPC G06Q 20/382; G06Q 20/045; H04L 9/0852; H04L 9/3234; G06Q 2220/00; H04L 2209/34; H04L 2209/56
USPC 705/67

(57) ABSTRACT

A quantum ticket is defined by a unique serial number; and a set of qubits, each qubit encoding quantum information. The serial number and the set of qubits are distributed only among one or more trusted verifiers who require a tolerance fidelity Fₜₒₗ in order to authenticate the token, where Fₜₒₗ represents a minimum percentage of correct outcomes during authentication of the serial number and the set of qubits. The experimental fidelity Fₑₓₚ for the quantum token is greater than the Ft0i set by the verifiers, so that an honest user of the quantum ticket who achieves Fₑₓₚ is exponentially likely to be successfully authenticated when seeking authentication by any of the trusted verifiers. The forging fidelity F_{forg} for the quantum token is less than Ft0i, so that a dishonest user who achieves F_{forg} and attempts forgery of the quantum ticket is exponentially likely to fail to obtain authentication for his forged ticket.

### CROSS-REFERENCE TO RELATED APPLICATIONS

The present application is based upon, and claims the benefit of priority under 35 U.S.C. §119, to co-pending U.S. Provisional Patent Application No. 61579,805 (the “'805 provisional application”), filed Dec. 23, 2011 and entitled “Unforgeable Noise-Tolerant Quantum Tokens.” The content of the '805 provisional application is incorporated herein by reference in its entirety as though fully set forth.

### BACKGROUND

The laws of quantum mechanics, in particular the no-cloning theorem, guarantee that any attempt at counterfeiting a credit card, bank note, bill, coin, or other type of payment-related object will fail if the object is embedded with quantum information. However, this security holds only under perfect conditions, whereas in real life quantum information is subject to noise, decoherence, and operational imperfections, all of which provide loopholes that dishonest users can exploit.

Because it is impossible to completely eliminate these imperfections, the development of secure “quantum money”—type protocols that can tolerate some noise and still remain secure is of practical importance.

### BRIEF DESCRIPTION OF THE DRAWINGS

The drawings disclose illustrative embodiments. They do not set forth all embodiments. Other embodiments may be used in addition or instead.

FIG. 1 illustrates a qticket (quantum ticket) in accordance with some embodiments of the present invention, and shows how soundness of the qticket can be proved.

FIG. 2 schematically illustrates a quantum retrieval situation for a cv-qticket (classical verification-qticket) in accordance with some embodiments of the present invention.

FIG. 3 is a table showing one example of verification of a single cv-qticket.

FIG. 4 illustrates a possible use of a cv-qticket to implement a quantum-protected credit card.

FIG. 5 illustrates a dishonest user of a quantum credit card who attempts to copy a concert ticket, by assigning an identical serial number, to allow his henchman to enter using an alternate checkpoint gate.

### DESCRIPTION

Illustrative embodiments are discussed in this application. It should be understood that the invention is not limited to the particular embodiments described. The terminology used herein is for the purpose of describing particular embodiments only, and is not intended to be limiting, since the scope of the present invention will be limited only by the appended claims.

Unless defined otherwise, all technical and scientific terms used herein have the same meaning as commonly understood by one of ordinary skill in the art to which this invention belongs. Although any methods and systems similar or equivalent to those described herein can also be used in the practice or testing of the present invention, a limited number of the exemplary methods and systems are described herein.

In the present application, the terms “qticket” and “quantum ticket” have the same meaning, and are used interchangeably.

In the present application, the terms “qubit” and “quantum bit” have the same meaning, and are used interchangeably.

In the present application, the terms “quantum token” and “quantum ticket” have the same meaning, and are used interchangeably.

As known by the laws of quantum mechanics, the possession of an object carrying quantum information does not guarantee that the holder can extract a complete description. The reason is that, while measurements may provide partial access, they do not necessarily allow for a full reconstruction of the original quantum state, since the act of measurement itself may alter or perturb the quantum state per the Heisenberg uncertainty principle.

“Quantum money” protocols, originally developed by Wiesner, are based on the realization that such quantum properties might allow for the design of a quantum “bank note” which is intrinsically and fundamentally immune to counterfeiting. Recent extensions to Wiesner's original “quantum money” protocol, in particular an extended protocol that makes it possible for quantum tokens to be authenticated via classical public communication with a trusted verifier.

These extended protocols all assume that the verification process is noise-free and can occur perfectly. Practically, this is never the case, however. Any verification process has to condone a certain finite fraction of quantum bit (or qubit) failures, in actuality. With the addition of noise, the security itself of previous extended proposals is at issue.

In some embodiments of the present application, quantum tickets are disclosed that ensure security of the protocol, as well as ensuring tolerance to finite errors associated with encoding, storage and coding of individual quantum bits. Each one of these qtickets is issued by a mint, and consists of a unique serial number and N component quantum states, ρ= [symbol] ᵢρᵢ, where each ρᵢ is drawn uniformly at random from an orthogonal set of eigenstates.

As one example, in some embodiments p, may be drawn from a set Q of polarization eigenstates of the Pauli spin operators. In these embodiments, Q is given by:

Q={|+ [symbol] ·|− [symbol] ·|+i [symbol] ·|−i [symbol] ·|0 [symbol] ·|1 [symbol] }.

It should be understood that in other embodiments, eigenstates other than the polarization eigenstates of the Pauli spin operators may be used, as long as the eigenstates are orthogonal.

The mint secretly stores a classical description of ρ, which is distributed only among one or more trusted verifiers. In order to redeem a qticket, the holder physically deposits it with a trusted verifier, who measures the qubits in the relevant basis. This verifier then requires a minimum fraction Fₜₒₗ of correct outcomes, i.e. correct matchings with the previously stored qubits, in order to authenticate the qticket. Following successful authentication or validation, the only information returned by the verifier is whether the qticket has been accepted or rejected.

The soundness of the above-described qticket is the probability that an honest user is successfully verified or authenticated. Such a probability depends crucially on the experimental fidelities associated with single qubit encoding, storage, and decoding. For a given qubit ρᵢ, a map Mᵢ can be defined, which characterizes the overall fidelity, beginning with the mint's encoding and ending with the verifier's validation. The average channel fidelity for each qubit ρᵢ is then given by:

Fᵢ=1/|Q|Σ_{ρ}, Tr[ρᵢMᵢ(ρᵢ)].

Using the above definition, the verification probability ρₕ of an honest user is:

$${P}_{h} = \frac{1}{\vert Q \vert} {\sum }_{ρ ∈ Q}^{ } Tr [ {P}_{acc} M ( ρ ) ] \geq 1 - {e}^{- ND ( {F}_{exp} ‖ {F}_{tol} )} .$$

In the above mathematical expression for Pₕ, P_{acc} represents the projector onto the subspace of valid qtickets, M= [symbol] ᵢMᵢ, Fₑₓₚ=1/NΣᵢFᵢ is the per qubit average experimental fidelity, and the relative entropy D is a measure of distinguishability between two binary probability distributions.

In the above embodiments, as long as the average experimental fidelity Fₑₓₚ associated with single qubit processes is greater than the tolerance fidelity Fₜₒₗ, an honest user is exponentially likely to be verified. In particular, the likelihood of successful verification is exponential in N, the number of initial qubits.

In the above-described qticket, each qubit is considered to be in one of six possible states. In this case, more than one bit of information may be extracted by measuring the actual state, which is insufficient to recover the original classical description. As explained above, in other embodiments different sets of qubits or possible quantum states may be used or considered.

As further described below, any attempts to forge two copies from a single qticket will lead at least one of the copies to be sufficiently imperfect, ultimately yielding its rejection at the hands of a trusted verifier, both tickets being imperfect.

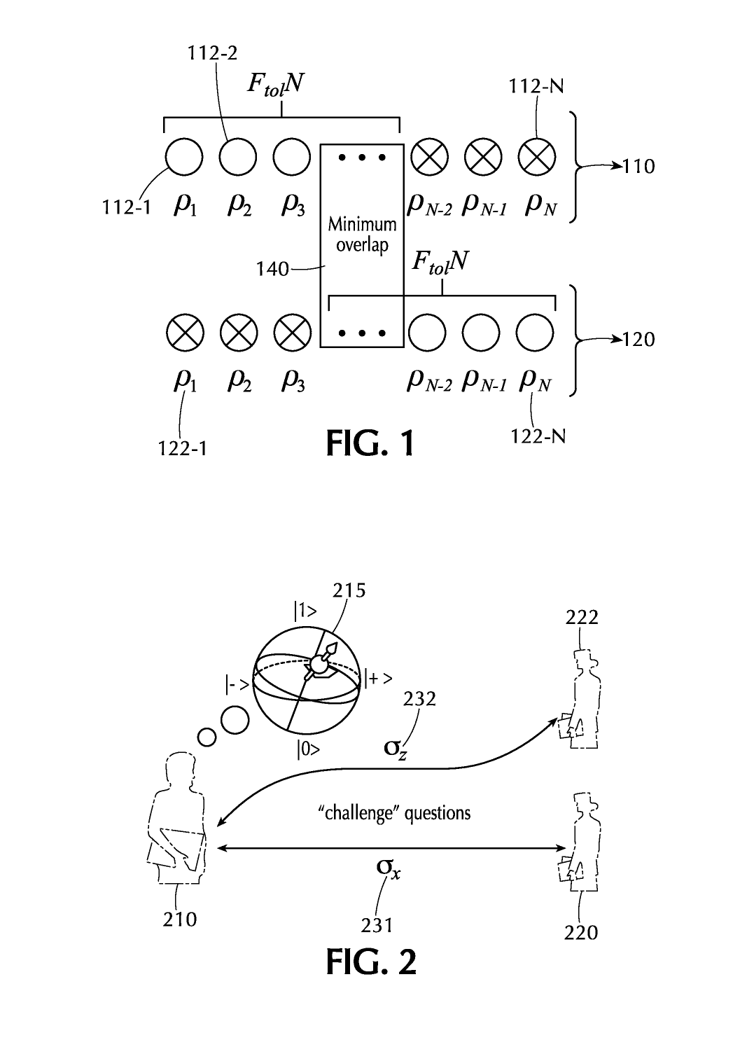

FIG. 1 illustrates a qticket (quantum ticket) in accordance with some embodiments of the present invention, and schematically shows how soundness of the qticket can be proved. In FIG. 1, an original qticket 110 has N qubits p, (indicated with reference numerals 111-1, 111-2, . . . , 111-N). Likewise, a cloned qticket 120 has N qubits ρᵢ (indicated with reference numerals 122-1, 122-2, . . . , 122-N).

For a given tolerance fidelity Fₜₒₗ, the qticket 110 having N qubits is only successfully authenticated if it contains at least FₜₒₗN valid qubits. However, for two counterfeit qtickets, not all valid qubits must coincide.

To determine a tight security threshold, the counterfeiting of a single qticket 110 is considered, as depicted in FIG. 1. For a given tolerance fidelity Fₜₒₗ set by the trusted verifiers, a qticket (containing N qubits) is only accepted if at least FₜₒₗN qubits are validated, i.e. the qticket 110 is only successfully authenticated if it contains at least FₜₒₗN valid qubits. However, for two counterfeit qtickets, not all valid qubits must coincide.

In the event that a dishonest user attempts to generate two qtickets from a single valid original, each must contain a minimum of FₜₒₗN valid qubits to be authenticated, as shown in FIG. 1. In order for each counterfeit qticket to contain FₜₒₗN valid qubits, a minimum of (2Fₜₒₗ−1) N. qubits must have been perfectly cloned. Thus, for a set tolerance fidelity in order for a dishonest user to succeed, he or she must be able to emulate a qubit cloning fidelity of at least 2Fₜₒₗ−1.

So long as this fidelity is above a fidelity F_{forg} achievable for optimal qubit cloning, as allowed by the laws of quantum mechanics, a dishonest user is exponentially unlikely to succeed in getting his/her forged ticket authenticated:

$${p}_{d} = \frac{1}{\vert Q \vert} {\sum }_{ρ ∈ Q}^{ } Tr [ {P}_{acc}^{⊗ 2} T ( ρ ) ] \leq {e}^{- ND ( 2 {F}_{tol} - 1 ‖ 2 \text{/} 3 )} .$$

where T represents any completely positive trace preserving (CPTP) qticket counterfeiting map. To ensure 2Fₜₒₗ−1>2/3,the tolerance fidelity Fₜₒₗ must be greater than ⅚, which is precisely the average fidelity of copies produced by an optimal qubit cloning map.

While in certain situations, an adversary may be able to sequentially engage in multiple verification rounds, the probability of successfully validating counterfeited qtickets grows at most quadratically in the number of such rounds, and hence, the likelihood of successful counterfeiting can remain exponentially small even for polynomially large numbers of verifications.

The qticket 110 in FIG. 1 is a direct transfer qticket which is physically transferable to trusted verifiers, such as concert tickets, by way of example. In many situations, this assumption of physical deposition may either be impossible or undesirable.

It has been shown that it remains possible, even remotely, for a holder to prove the validity of a token by responding to a set of “challenge” questions; these questions can only be successfully answered by measuring an authentic token. Core to this approach is to ensure that the challenge questions reveal no additional information about the quantum state of the token. The holder of a valid token should be capable of answering any single challenge question correctly yet be restricted to an exponentially small probability of satisfactorily answering two of them.

In some embodiments of the present application, classical verification quantum tickets (or “cv-qtickets”) that are robust against noise and operational imperfections are implemented. In contrast to the case of bare qtickets, a cv-qticket holder will be expected to answer challenge questions and hence to measure qubits himself, or with a machine at a store. Alternatively, the cv-qticket holder or user may swipe his quantum credit card at a store, and the machine communicates via a classical channel to one or more trusted verifiers and may directly measure or answer the challenge questions.

The possibility of a dishonest holder participating simultaneously in multiple remote verifications is contemplated. This possibility could in principle offer the counterfeiter an additional advantage with respect to the qticket scenario. In particular, certain measurement strategies, which may be chosen posterior to receiving a set of challenge questions, may yield an increased likelihood for multiple successful authentications.

FIG. 2 schematically illustrates a quantum retrieval type situation for a cv-qticket in accordance with some embodiments of the present invention. In the situation illustrated in FIG. 2, two verifiers 220 and 222 ask a holder 210 complementary challenge questions. As further described below, a challenge question consists of requesting the holder 210 to measure each block of qubits along a basis chosen randomly among either X (shown as 231 in FIG. 2) or Z (shown as 232 in FIG. 2). In the illustrated situation, the optimal strategy for the holder 210 is to measure in an intermediate basis 215. Such a strategy saturates the tolerance threshold, which in the illustrated case is given by:

$${F}_{tol}^{cv} = \frac{1 + 1 / \sqrt{2}}{2} .$$

One example of a cv-qticket framework utilizes as a building block a set of eight possible two-qubit product states, each consisting of two polarization eigenstates (one along X and the other along Z):

S={0·+ [symbol] ·|0·− [symbol] ·|1·+ [symbol] ·|1·− [symbol] ·|+·0 [symbol] ·|−·0 [symbol] ·|+·1 [symbol] ·|−·1 [symbol] }

These states constitute a minimal set with the following properties: (1) Only preparation and measurement of qubit states is required; and (2) Each state enables the deterministic answering of either of two complementary challenge questions, for example, a request to measure both X polarizations or both Z polarizations, thereby automatically ensuring soundness in the case of perfect experimental fidelity. When attempting to use the state to answer two complementary challenges from independent verifiers, on average, only 1+1/√2 of replies is correct. Thus, it is possible for a dishonest user to emulate an experimental fidelity (per qubit) of no more than 1/2+1/√8≈0.85 with respect to each verifier.

It should be understood that in other embodiments, the number of two-qubit product states can be different from eight, and orthogonal eigenstates other than polarization eigenstates may be used.

In some embodiments, each cv-qticket may be envisioned as consisting of n blocks, each containing r qubit pairs, and thus, a total of n×r×2 qubits. Again, each of the qubit pairs is chosen uniformly at random from the set S. A challenge question consists of requesting the holder to measure each block (of qubits) along a basis chosen randomly among either X or Z.

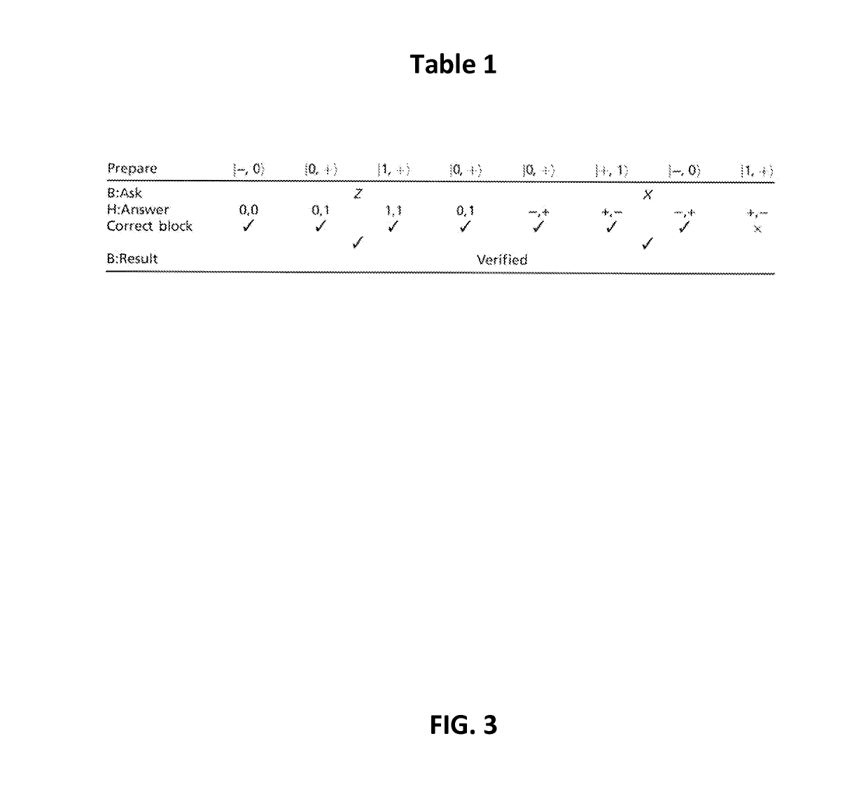

FIG. 3 is a table showing an example of verification of a single cv (classical verification)—qticket. In the table set forth in FIG. 3, a cv-qticket with n=2 and r=4 is considered, totaling eight qubit pairs and Fₜₒₗ=3/4 (just for illustrative purposes). In FIG. 3, the prepared qubit-pairs are chosen at random, as are the bank's requested measurement bases (for each block). The holder's answer has at most, a single error per block, which according to Fₜₒₗ=3/4 is allowed. As explained above, secure cv-qtickets require Fₜₒₗ^{cv}>1/2+1/√8, and a larger number of constituent qubits.

As depicted in the table in FIG. 3, a valid qubit pair (within a block) is one in which the holder correctly answers the orientation for the particular qubit (within the pair) that was prepared along the questioned basis. For a given tolerance threshold F^{cv}ₜₒₗ, an overall answer will only be deemed correct if at least f^{cv}ₜₒₗ orientations within each of the n blocks are found valid. The motivation for taking blocks of 2r qubits is to exponentially suppress the probability that a counterfeiter provides more than 2Fₜₒₗ^{cv}r>(1+1/√2)r correct answers among two complementary challenge blocks.

In turn, because any two verifiers choose the questions for each block independently and at random, the probability that there exist no complementary blocks scales exponentially with the number of blocks as 2⁻ⁿ. By contrast, if one were to dismiss this block structure, an adversary would be able to emulate a larger average experimental fidelity (3/4+2/√32≈0.93) by choosing a measurement basis for each pair dependent on whether the corresponding requests are coinciding or complementary.

By analogy to the direct-transfer qticket case described above, honest users of cv-qtickets are exponentially likely to be verified so long as Fₑₓₚ>F^{cv}ₜₒₗ. In particular, because there now exist is blocks of qubits, each of which can be thought of as an individual qticket (with r qubits), the probability P^{cv}ₕ that the honest user will be successfully verified is given by:

pₕ^{cv}≧(1−e^{-rD(F}^{ₑₓₚ}^{∥F}^{ₜₒₗ}^{^{cv}}⁾)ⁿ

Mathematical proofs of cv-qticket security for the above-described cv-qticket based upon a generalized formalism of quantum retrieval games, in combination with a generalized Chernoff-Hoeffding bound, are provided in Exhibit II (the Supplemental information section) of the '805 provisional application, the contents of which have been incorporated by reference in their entireties.

So long as Fₜₒₗ^{cv}>1/2+1/√8, a dishonest user is exponentially unlikely to be authenticated by two independent verifiers. The threshold 1/2+1/√8 corresponds exactly to that achievable by either covariant cubit cloning or by measurement in an intermediate basis (as illustrated in FIG. 2), suggesting that both such strategies may be optimal.

Likewise, by analogy to the direct-transfer qticket case described in conjunction with FIG. 1, a dishonest user of a cv-qticket is also exponentially likely to fail, with a probability p^{cv}_{d} given by:

$${p}_{d}^{cv} \leq {( \begin{matrix}v \\ 2\end{matrix} )}^{2} {( 1 \text{/} 2 + {e}^{- rD ( {F}_{tol}^{cv} ‖ 1 \text{/} 2 + 1 / \sqrt{8} )} )}^{n} ,$$

where v represents the number of repeated verification attempts.

In the above equation, the factor of (^{v}₂)² results from a combinatorial statement accounting for the possibility of choosing which challenge question to answer first and then waiting for feedback from the verifier. Thus, so long as the hierarchy of fidelities is such that: 1/2°1/√8<V^{cv}ₜₒₗ<Fₑₓₚ, it is possible to mathematically prove both soundness and security of the cv-qtickets protocol. Further details of such proof is found in Exhibit II of the '805 provisional application, the contents of which are incorporated herein by reference in their entireties.

In some embodiments, the primitives described above may be applied to practically relevant protocols. As one example, one might imagine a composite cv-qticket that allows for multiple verification rounds while also ensuring that the ticket cannot be split into two independently valid subparts. Such a construction may be used to create a quantum-protected credit card.

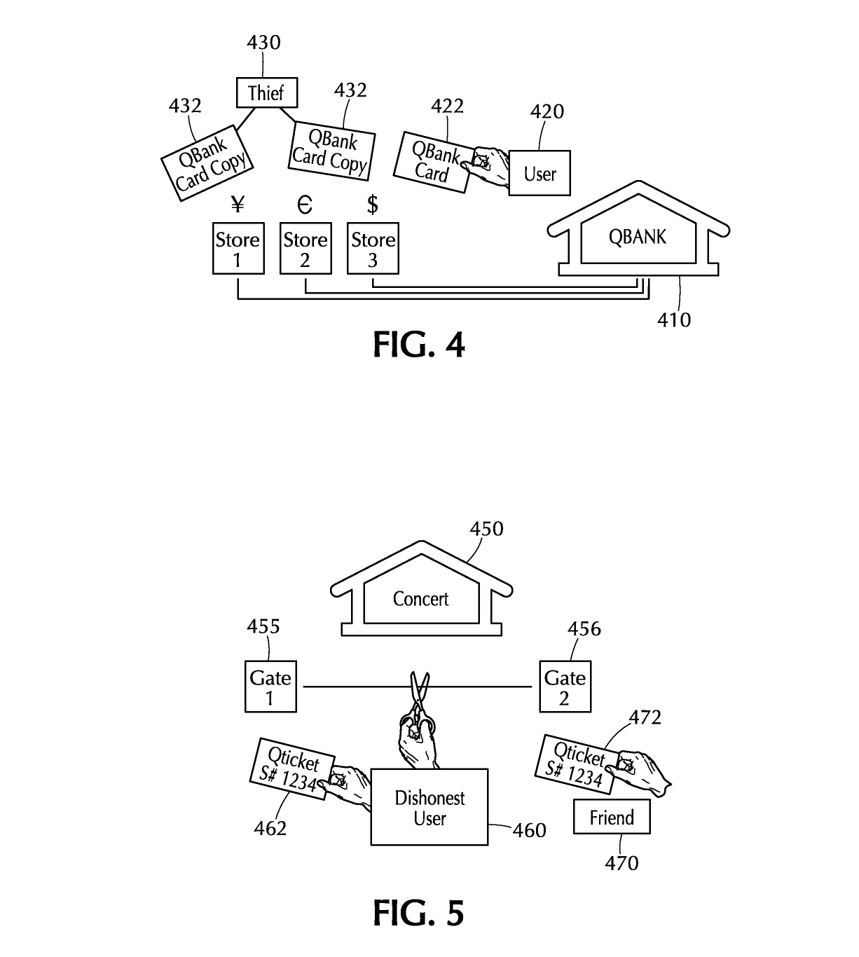

FIG. 4 illustrates one example of a possible use of the above-described cv-qticket framework to implement a quantum-protected credit card. In the situation illustrated in FIG. 4, a user 420 has be cv-qticket issued by a quantum bank (shown as “Qbank” in FIG. 4) 410, in the form of a QBank card 422. A thief 430 clones two identical copies 432 of the Qbank card 422, and attempts to use the copies 432 in different stores, shown as store 1, store 2, and store 3.

The classical communication that takes place with the issuer (for example a bank) to verify the cv-qticket, via challenge questions, may be intentionally publicized to a merchant who needs to be convinced of the card's validity. By contrast to modern credit card implementations, such a quantum credit card would be unforgeable and hence immune to fraudulent charges, as illustrated in FIG. 4. Unlike its classical counterpart, the quantum credit card would naturally be unforgeable, preventing thieves from being able to simply copy credit card information and perform remote purchases.

FIG. 5 illustrates a situation where the trusted verifiers may not possess a secure communication channel with each other. In particular, FIG. 5 illustrates a dishonest user 460 who seeks to copy multiple concert tickets 462 and 472, i.e. to create more than one concert ticket with the same serial number. The dishonest user 460 attempts to make it possible for his henchman or friend 470 to enter the concert 450 at an alternate checkpoint gate 456 (“Gate 2”), different from his own checkpoint gate 455 (“Gate 1”).

Naively, each verifier (at gates 455 and 456, respectively) would be thought as being able to communicate with one another to prevent such abusive ticket cloning. However, such a safeguard can be overcome in the event that the communication among verifiers is either unsecured, unavailable, or severed (possibly by the dishonest user himself). The qticket is exempt from this type of attack because security is guaranteed even in the case of isolated verifiers.

A classical solution would involve gate verifiers communicating amongst one another to ensure that each ticket serial number is only allowed entry a single time. As shown in FIG. 5, however, such a safeguard can be overcome in the event that communication has been severed. By contrast, a concert ticket based upon the proposed qticket primitive would be automatically secure against such a scenario. Indeed, the security of qtickets is guaranteed even when verifiers are assumed to be isolated. This kind of isolation may be especially useful for applications involving quantum identification tokens, where multiple verifiers may exist who are either unable or unwilling to communicate with one another.

The above embodiments have described quantum primitives based upon single tokens. Natural extensions to the case of multiple identical quantum tickets open up the possibility of even more novel applications.

In some embodiments of the present application, the above threshold results are extended to the case where c identical copies of the quantum ticket are issued. In this case, to ensure that the production of c+1 valid tokens is exponentially improbable, the required threshold fidelity must be greater than

$$1 - \frac{1}{( c + 1 ) ( c + 2 )} .$$

The existence of such multiple identical tokens can provide a certain degree of anonymity for users and could be employed in primitives such as quantum voting.

Rigorous mathematical proofs of the soundness and security of direct-transfer qtickets, described in conjunction with FIG. 1, and of classically verifiable cv-tickets are provided in Exhibit II of the '805 provisional application, the contents of which have been incorporated by reference in their entireties.

In some embodiments, a processing system may be configured and used to implement the methods, systems, and techniques described in the present application. The processing system may include, or may consist of, any type of microprocessor, nanoprocessor, microchip, or nanochip. The processing system may be selectively configured and/or activated by a computer program stored therein. It may include a computer-usable medium in which such a computer program may be stored, to implement the methods and systems described above. The computer-usable medium may have stored therein computer-usable instructions for the processing system. The methods and systems in the present application have not been described with reference to any particular programming language; thus it will be appreciated that a variety of platforms and programming languages may be used to implement the teachings of the present application.

In some embodiments, a computer-usable medium having stored therein computer-readable instructions for a processing system, wherein said instructions when executed by said processing system cause the processing system to measure a set of qubits in a quantum ticket and compare the measured values with stored values, and to authenticate the quantum ticket only if the correct outcomes are greater than a tolerance fidelity Fₜₒₗ.

In sum, a novel class of secure “quantum money”-type primitives capable of tolerating realistic infidelities have been disclosed, and their tolerance to noise has been shown. The protocols proposed in the present application require only the ability to prepare, store, and measure single quantum bit memories, making their experimental realization accessible with current technologies.

Nothing that has been stated or illustrated is intended to cause a dedication of any component, step, feature, object, benefit, advantage, or equivalent to the public. While the specification describes particular embodiments of the present disclosure, those of ordinary skill can devise variations of the present disclosure without departing from the inventive concepts disclosed in the disclosure. While certain embodiments have been described, it is to be understood that the concepts implicit in these embodiments may be used in other embodiments as well. In the present disclosure, reference to an element in the singular is not intended to mean “one and only one” unless specifically so stated, but rather “one or more.” All structural and functional equivalents to the elements of the various embodiments described throughout this disclosure, known or later come to be known to those of ordinary skill in the art, are expressly incorporated herein by reference.

What is claimed is:

1. A quantum ticket, comprising
a unique serial number; and
N component quantum qubits ρ= [symbol] ᵢρᵢ(i=1, . . . N);
wherein the serial number and ρ are distributed only among one or more trusted verifiers who require a tolerance fidelity Fₜₒₗ in order to authenticate the token, Fₜₒₗ representing a minimum percentage of correct outcomes during authentication of S and ρ;
wherein an experimental fidelity Fₑₓₚ for the quantum token is greater than Fₜₒₗ; and
wherein an honest user of the quantum ticket who achieves Fₑₓₚ is exponentially likely to be successfully authenticated when seeking authentication by direct transfer to any of the trusted verifiers.

2. The quantum ticket of claim 1, wherein a forging fidelity F_{forg} for the quantum token is less than Fₜₒₗ, such that a dishonest user who achieves F_{forg} and attempts forgery of the quantum ticket is exponentially unlikely to be successfully authenticated when seeking authentication by direct transfer to any of the trusted verifiers, so that:
F_{forg}<Fₜₒₗ<Fₑₓₚ.

3. The quantum ticket of claim 1, wherein each one of the qubits are drawn at random from an orthogonal set of eigenstates.

4. The quantum ticket of claim 3, wherein the eigenstates are polarization eigenstates of the Pauli spin operators, and wherein the polarization eigenstates are given by:
{|0 [symbol] ·|1 [symbol] ·|° [symbol] ·|− [symbol] ·|°i [symbol] ·|−i [symbol] }

5. The quantum ticket of claim 1, wherein the quantum ticket has a soundness corresponding to a probability Pₕ that the honest user be successfully authenticated when seeking authentication by direct transfer to any of the trusted verifiers, and wherein the probability Pₕ is given by:
$${p}_{h} = \frac{1}{\vert Q \vert} {\sum }_{ρ ∈ Q}^{ } Tr [ {P}_{acc} M ( ρ ) ] \geq 1 - {e}^{- ND ( {F}_{exp} ‖ {F}_{tol} )} .$$
where Q=Q [symbol] ^{N};
P_{acc} represents a projector onto the subspace of valid qtickets;
M= [symbol] ᵢM_{i,};
Fₑₓₚ=1/NΣᵢFᵢ is a per qubit average experimental fidelity; and
relative entropy D is a measure of distinguishability between two binary probability distributions.

6. The quantum ticket of claim 2, wherein the quantum ticket has a security corresponding to a probability P_{d} that a dishonest user fails to have his forged ticket authenticated when seeking authentication by direct transfer to any of the trusted verifiers, and wherein the probability P_{d} is given by:
$${p}_{d} = \frac{1}{\vert Q \vert} {\sum }_{ρ ∈ Q}^{ } Tr [ {P}_{acc}^{⊗ 2} T ( ρ ) ] \leq {e}^{- ND ( 2 {F}_{tol} - 1 ‖ 2 \text{/} 3 ) .} .$$

7. The quantum ticket of claim 2, wherein for a given F₁₀₁, a minimum forging fidelity F_{forg} that a dishonest user must emulate, in order to have a ticket that he forged successfully authenticated, is given by:
F_{forg}<2Fₜₒₗ−1

8. The quantum ticket of claim 2, wherein Fₜₒₗ and F_{forg} are defined so that any attempt by any user at forging more than one the quantum ticket leads to both of the copies being sufficiently imperfect so as to be rejected by all the trusted verifiers.

9. The quantum ticket of claim 2, wherein upon issuance of c identical copies of the quantum ticket, a tolerance fidelity Fₜₒₗ that is required in order to exclude the possibility that a (c+1)^{th} copy of the quantum ticket be successfully verified, is greater than:
$$1 - \frac{1}{( c + 1 ) ( c + 2 )} .$$

10. The quantum ticket of claim 9, wherein a probability that a (c+1)^{th} copy of the quantum ticket is successfully verified, after c identical copies of the quantum ticket have been issued, is less than or equal to:
$${e}^{- ND ( ( c + 1 ) {F}_{tol} - c ‖ \frac{c + 1}{c + 2} )} .$$

11. A quantum ticket, comprising:
a unique serial number; and
a set containing a plurality N of two-qubit product states, each state allowing for a deterministic answering of either one of two complementary challenge questions, the serial number and the set of two-qubit product states distributed only among one or more trusted verifiers who require a tolerance fidelity F^{cv}ₜₒₗ in order to remotely verify the token through a classical channel;
wherein an experimental fidelity Fₑₓₚ for the classically verifiable quantum token is greater than F^{cv}ₜₒₗ; and
wherein an honest user of the quantum ticket who achieves Fₑₓₚ is exponentially likely to be successfully authenticated when seeking remote verification of the ticket by communication with any of the trusted verifiers over a classical channel.

12. The quantum ticket of claim 11, wherein the quantum ticket has a soundness corresponding to a probability P^{cv}^{h} that the honest user be successfully authenticated when seeking remote authentication from any of the trusted verifiers through a classical channel, and wherein the probability P^{cv}ₕ given by:
Pₕ^{cv}≧(1−e^{-rD(F}^{ₑₓₚ}^{∥F}^{ₜₒₗ}^{^{cv}}⁾)ⁿ

13. The quantum ticket of claim 11, wherein a dishonest user is exponentially unlikely to be authenticated by two independent verifiers, as long as Fₜₒₗ^{cv}>1/2+1/√8.

14. The quantum ticket of claim 13, wherein the quantum ticket has a security corresponding to a probability P^{cv}_{d} that a dishonest user fails to obtain authentication for a forged ticket, when seeking remote authentication from any of the trusted verifiers through a classical channel, and wherein the probability P^{cv}_{d} given by:
$${p}_{d}^{cv} \leq {( \begin{matrix}v \\ 2\end{matrix} )}^{2} {( 1 \text{/} 2 + {e}^{- rD ( {F}_{tol}^{cv} ‖ 1 \text{/} 2 + 1 / \sqrt{8} )} )}^{n} .$$

15. The quantum ticket of claim 11, comprising a quantum credit card.

16. The quantum ticket of claim 11, wherein each one of the plurality N of two-qubit product states comprises two orthogonal eigenstates along mutually perpendicular directions.

17. The quantum ticket of claim 16, wherein N=8, and wherein each one of the two-qubit product states comprises two polarization eigenstates along mutually perpendicular directions; and
wherein the set of polarization eigenstates is given by:
{|0·+ [symbol] ·|0·− [symbol] ·|1·+ [symbol] ·|1·− [symbol] ·|+·0 [symbol] ·|+·1 [symbol] |−·1 [symbol] }

18. A method comprising:
measuring a set of qubits in a quantum ticket and comparing the measured values with previously stored values, and
authenticating the quantum ticket only if the percentage of correct outcomes are greater than a tolerance fidelity Fₜₒₗ;
wherein the previously stored values have been distributed only to one or more trusted verifiers.

19. The method of claim 18, wherein the quantum ticket has an experimental fidelity Fₑₓₚ that is greater than Fₜₒₗ, so that an honest user of the quantum ticket who achieves Fₑₓₚ is exponentially likely to be successfully authenticated when seeking authentication from the trusted verifiers.

20. The method of claim 18, wherein the quantum ticket has a forging fidelity F_{forg} that is less than Fₜₒₗ, so that a dishonest user who achieves F_{forg} and attempts forgery of the quantum ticket is exponentially unlikely to be authenticated when seeking authentication from any of the trusted verifiers.

21. The method of claim 20, wherein F_{forg} is a maximum possible fidelity of a forged ticket allowed by quantum mechanics.

22. A computer-usable medium having stored therein computer-readable instructions for a processing system, wherein said instructions when executed by said processing system cause the processing system to measure a set of qubits in a quantum ticket and compare the measured values with stored values, and to authenticate the quantum ticket only if the correct outcomes are greater than a tolerance fidelity Fₜₒₗ.
